(19) United States
(12) Patent Application Publication
(10) Pub. No.: US 2015/0371544 A1
(43) Pub. Date: Dec. 24, 2015

(54) METHOD AND DEVICE TO ESTIMATE COSTS OF DEVIATION IN A FLIGHT TRAJECTORY

(71) Applicant: AIRBUS OPERATIONS (S.A.S.), Toulouse (FR)

(72) Inventor: Jean-Claude MERE, Verfeil (FR)

(21) Appl. No.: 14/743,823

(22) Filed: Jun. 18, 2015

(30) Foreign Application Priority Data
Jun. 19, 2014 (FR) 1455653

(51) Int. Cl. G08G 5/00

(52) U.S. Cl. CPC G08G 5/0039

(57) ABSTRACT

A method and device for determining and presenting cost impacts generated by lateral route deviations of an aircraft. The device includes a computation unit for determining different flight trajectories, called alternative trajectories, each of which is offset laterally in the horizontal plane relative to a reference trajectory, notably the current trajectory of the aircraft, and a computation unit configured to compute, for each of the alternative trajectories, an associated overall cost which provides an indication of the cost generated by a flight of the aircraft along this alternative trajectory, the device also includes a display unit configured to present, on a navigation screen, indication elements which provide indications concerning the position and the associated overall cost for at least some of the alternative trajectories.

### RELATED APPLICATION

This application claims priority to French patent application 1455653 filed Jun. 19, 2014, the entirety of which is incorporated by reference.

### BACKGROUND OF INVENTION

The present invention relates to a method and a device for determining and presenting cost impacts generated by lateral route deviations of an aircraft relative to a flight trajectory called reference trajectory.

It is known that an aircraft, in particular a transport airplane, is provided with a flight management system (FMS), e.g., a specialized computer, which is intended to define a trajectory to be followed by the aircraft. This FMS system enables the crew of the aircraft notably to modify parameters of the trajectory, in particular the position of points of the flight plan in the horizontal plane.

Upon such a modification or change, the FMS system generally recomputes predictions (estimated times of passage and quantity of fuel remaining at the vertical to the points of the flight plan) on the new flight plan, which enables the crew to assess the impacts induced by the change (of strategy) thus modeled in the FMS system, notably concerning the time of arrival and the quantity of fuel remaining at destination (or at another point).

The changes can be relatively complex (several points can for example be modified or inserted in the flight plan), but the need to model the changes in a flight plan induces the following two limitations:

a. the crew can assess only one strategy at a time, which means that it must, if it wants to compare a number of strategies notably to identify the most advantageous, perform several modifications to its flight plan and store or score the impacts (remaining quantity of fuel and time of arrival at destination for example) corresponding to each strategy to be able to make the comparison; and

b. the computation of the predictions along the amended flight plan takes a long time (several minutes depending on the changes made), which, in the case where the crew wants to assess a number of strategies, can become prohibitive if a rapid decision needs to be taken.

Moreover, when a weather disturbance occurs on the active flight plan (that is to say on the flight plan actually being followed by the aircraft), the crew has a number of options to avoid it, and notably that of performing a lateral avoidance maneuver.

To assist it in this task, the crew generally has, on a navigation screen of the aircraft, a representation of the lateral environment of the aircraft, containing a variety of information such as the flight plan, a video image of a weather radar, and different points assisting in the navigation of the FMS system.

Generally, the crew seeks to follow the path which disrupts its mission as little as possible and is therefore tempted to choose the shortest possible trajectory, enabling it to return to its initial flight plan. However, such a trajectory is not necessarily optimal in terms of fuel consumption and time. Indeed, the effects due to head winds are difficult to take into account in the construction of the avoidance trajectory by the crew.

Consequently, the crew has to perform a number of trajectory tests (construction of the new lateral profile, entry of wind data, computation of the predictions), before finding the one which best fits the current situation.

Taken together, these tasks on the part of the crew to determine an optimal trajectory in terms of different criteria therefore present a significant workload.

### SUMMARY OF THE INVENTION

The present invention is to reduce the workload of the cockpit aircrew, e.g., pilots, by providing devices, e.g., specially programed flight computers (such as a FMS) programmed to determine and present to the aircrew potential trajectories for the aircraft and computed information regarding each of the trajectories. The invention may include a method for determining and presenting, on an aircraft, cost impacts generated by lateral route deviations (or lateral deviations) of the aircraft relative to a flight trajectory called reference trajectory.

The method may include the following steps, implemented automatically:

a. in determining a plurality of different flight trajectories, called alternative trajectories, each of said alternative trajectories being offset laterally in the horizontal plane relative to the reference trajectory;

b. in computing, for each of said alternative trajectories, an associated overall cost, an overall cost associated with an alternative trajectory providing an indication of the cost generated by a flight of the aircraft along this alternative trajectory; and

c. in presenting, on at least one navigation screen of the aircraft, indication elements, the indication elements providing indications concerning the position and the associated overall cost for at least some of said alternative trajectories.

Thus, by virtue of the method, the aircrew directly has, through the display produced on the navigation screen, visual indications (or information) concerning the position and the associated overall cost of alternative trajectories, that is to say of possible flight trajectories which are offset laterally relative to the reference trajectory, this reference trajectory preferably (but not exclusively) representing the current flight trajectory of the aircraft (that is to say that being followed at the current instant by the aircraft).

The information makes it possible, in particular, to provide assistance to the crew for assessing the relevance of a lateral deviation of the aircraft relative to the reference trajectory and, if appropriate, to choose the alternative trajectory to be followed, which makes it possible to reduce the workload of the crew in this situation.

Moreover, the method may include an additional step of: in determining, from the alternative trajectories, an optimal alternative trajectory in terms of cost; and in presenting this optimal alternative trajectory on the navigation screen.

The crew is thus informed of the alternative trajectory which is optimal in terms of cost (that is to say the one which presents a minimal overall cost) relative to the overall costs associated with the other possible alternative trajectories, which provides additional assistance to the crew and contributes to reducing its workload.

According to different embodiments of the invention, which will be able to be taken together or separately:

the method comprises an additional step consisting in allowing an operator to select an alternative trajectory presented on the navigation screen and activate it, the alternative trajectory selected and activated by an operator then being followed by the aircraft;

at least some of said alternative trajectories determined in the step a) exhibit at least different offset distances, an offset distance of any alternative trajectory representing a distance of constant value by which this alterative trajectory is offset laterally in the horizontal plane relative to the reference trajectory at least for a central portion of this alternative trajectory;

the step a) consists in determining alternative trajectories making it possible to avoid passing through given avoidance areas of the environment of the aircraft;

the steps a) and b) implement a multidimensional non-linear optimization method;

The method comprises an additional step consisting in saving the alternative trajectories, determined in the step a), and the associated overall costs, computed in the step b).

Furthermore, advantageously, the step b) consists, for each alternative trajectory:

b1) in computing a flight time along said alternative trajectory;

b2) in computing a so-called additional cost; and

b3) in determining the associated overall cost from a cost dependent on said flight time, and on said additional cost.

Preferably, the step b1) consists in computing the flight time ΔT by dividing the alternative trajectory into a plurality of subsegments and by computing and by aggregating the flight times ΔTi of all of said subsegments, the flight time ΔTi of any subsegment being computed using the following expression:

$$Δ Ti = \frac{Di}{{W}_{Lon} ( xi ) + \sqrt{{V}_{A / C} {i}^{2} - {{W}_{Lat} ( xi )}^{2}}}$$

in which:

W_{Lon}(xi) and W_{Lat}(xi) are, respectively longitudinal and lateral components of a wind speed existing on said sub-segment;

V_{A/C}i is a speed of the aircraft relative to the air; and

Di is a predetermined subsegment distance.

Furthermore, advantageously, the step b3) consists in computing the overall cost ΔC, using one of the following expressions:

ΔC=C_{F}·ΔT·(FF+CI)+C₀(ΔT)

ΔC=C_{F}·(ΔT+p(ΔT))·(FF+CI)

in which:

C_{F} is a cost expressed in a currency unit for a given quantity of fuel;

ΔT is said flight time;

FF is a parameter illustrating a fuel flow, this parameter being considered as constant;

CI is a cost index representing a ratio between a cost dependent on a flight time of the aircraft and a cost dependent on a fuel consumption of the aircraft;

C₀(ΔT) is a function dependent on time and comprising the additional cost; and

p(ΔT) is a time value incorporating the additional cost.

The present invention also relates to a device for determining and presenting, on an aircraft, cost impacts generated by lateral route deviations of the aircraft relative to a flight trajectory called reference trajectory.

The device comprises:

an information processing unit, such as a computer system including a processor accessing a non-transitory memory device storing instructions to be executed by the processor, and the information processing unit may comprise:

a first computation unit or set of program instructions configured to determine a plurality of different flight trajectories, called alternative trajectories, each of said alternative trajectories being offset laterally in the horizontal plane relative to the reference trajectory; and

a second computation unit or set of program instructions configured to compute, for each of said alternative trajectories, an associated overall cost, an overall cost associated with an alternative trajectory providing an indication of the cost generated by a flight of the aircraft along this alternative trajectory; and

a display unit configured to present, on at least one navigation screen of the aircraft, indication elements, the indication elements providing indications concerning the position and the associated overall cost for at least some of said alternative trajectories.

Furthermore, the information processing unit may comprise a third computation unit configured to determine, from said alternative trajectories, an optimal alternative trajectory, this optimal alternative trajectory being presented on the navigation screen by the display unit.

Moreover, the device may comprise:

an environment server, e.g. computer system, configured to supply, at least to the information processing unit, meteorological data, and avoidance areas defining flight areas that have to be avoided by the aircraft; and/or

a performance server configured to supply, at least to the information processing unit, information linked to the flight performance of the aircraft.

The present invention further relates to an aircraft, in particular a transport airplane, which is provided with a device such as that specified above.

### SUMMARY OF THE DRAWINGS

The attached figures will give a good understanding as to how the invention can be implemented. In these figures, identical references denote similar elements.

FIG. 1 is a block diagram of a device which illustrates an embodiment of the invention.

FIG. 2 shows a flight of an aircraft along a current flight trajectory subject to a disturbance.

FIGS. 3A to 3C show examples of polygons delimiting disturbances.

FIG. 4 is a diagram showing the characteristics of an alternative trajectory offset laterally relative to a current flight trajectory of an aircraft.

FIGS. 5 and 6 are two graphs illustrating examples of flight cost trend as a function of a delay.

FIG. 7 is a diagram making it possible to explain a computation of the flight time along a flight trajectory subsegment.

FIG. 8 is a diagram making it possible to explain a computation of a mean wind.

FIGS. 9 and 10 are graphs showing the trend of a cost as a function of an offset distance, respectively without and with a disturbance.

FIGS. 11 and 12 schematically show examples of display likely to be produced by a device according to the invention.

### DETAILED DESCRIPTION OF THE INVENTION

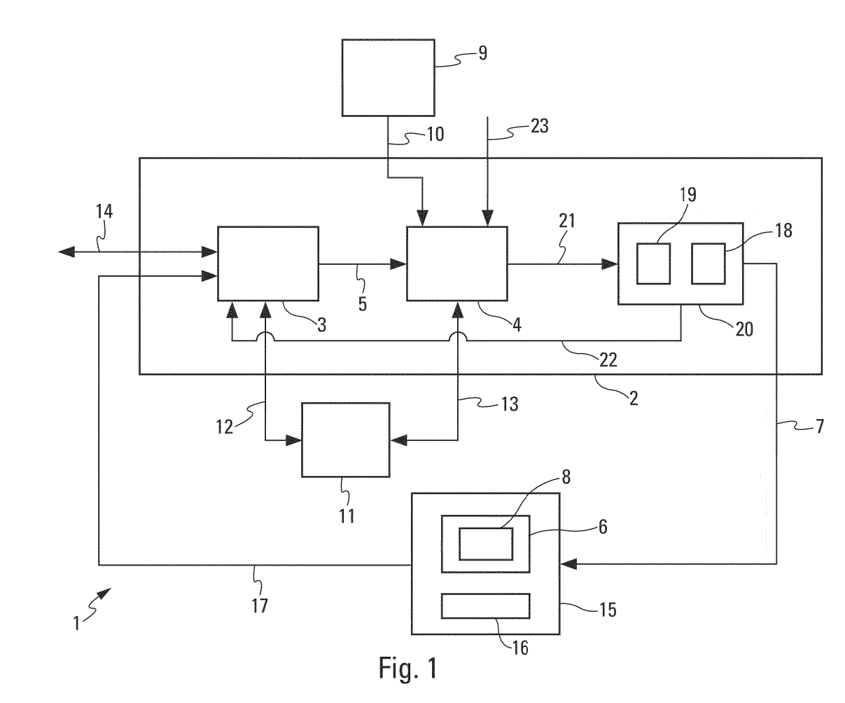

FIG. 1 schematically shows a device for determining and presenting, on an aircraft, in particular on a transport airplane, cost impacts relating to lateral deviations of the aircraft relative to a given flight trajectory, called reference trajectory. Preferably, although not exclusively, this reference trajectory is the current flight trajectory actually being followed at the current instant by the aircraft.

To do this, the device 1 which is embedded on the aircraft, comprises:

an information processing unit or central processing unit 2 which accesses a non-transitory storage unit 18 with program instructions which are executed by the unit 2, wherein the unit 2 includes:

a computation unit 3 configured to compute a plurality of flight trajectories called alternative trajectories. Each of said alternative trajectories is offset laterally in the horizontal plane relative to the reference trajectory, as specified below; and

a computation unit 4 linked via a link 5 to the computation unit 3 and configured to compute, for each of said alternative trajectories, an associated overall cost (specified hereinbelow); and

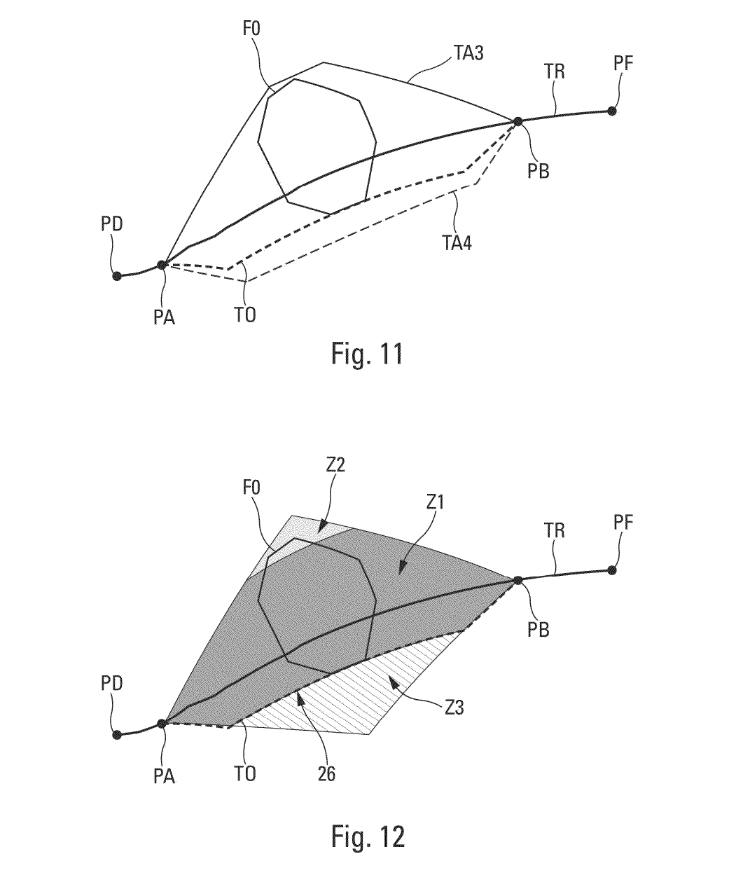

a display unit 6 which is linked to said central processing unit 2 via a link 7 and which is configured to present, on at least one navigation screen 8 of the aircraft, indication elements. These indication elements provide indications concerning the position and the associated overall cost for at least some of said alternative trajectories, as specified hereinbelow with reference to FIGS. 11 and 12 in particular.

Thus, by virtue of the device 1, the crew has, directly, through the display produced on the navigation screen 8, visual indications (or information) (specified hereinbelow) concerning the position and the associated overall cost of alternative trajectories. These alternative trajectories are possible flight trajectories which are offset laterally relative to the reference trajectory, this reference trajectory preferably (although not exclusively) representing the current flight trajectory of the aircraft. This information makes it possible, in particular, to provide assistance to the crew, on the one hand, for assessing the relevance of a lateral offset of the aircraft relative to the reference trajectory, and, on the other hand, for choosing, if appropriate, the alternative trajectory to be followed, which makes it possible to reduce the workload of the crew in this situation.

The device 1 may also comprise:

an environment server 9, specified hereinbelow, which supplies meteorological data and information defining envelopes of surrounding areas to be avoided, to the central processing unit 2 (via a link 10); and

a performance server 11 which is linked via links 12 and 13, respectively, to said computation units 3 and 4 of the central processing unit 2.

The performance server 11 supplies said computation units 3 and 4 with a variety of information (speed, weight, turn radius, etc.) linked to the performance and the flight qualities of the aircraft. In the context of a simplified solution specified hereinbelow, the performance server 11 supplies the speed at a point away from the reference trajectory (speed which is considered as constant for the rest of the avoidance).

Moreover, the central processing unit 2 receives, via a link 14, an initial flight plan from a flight management system (not represented), of FMS type, of the aircraft.

The central processing unit 2 further comprises a non-transitory storage unit 18 which saves the alternative trajectories, determined by the computation unit 3, and the associated overall costs, computed by the computation unit 4.

Moreover, in an embodiment, the central processing unit 2 comprises an optimum search unit 19, which is configured to determine an optimal alternative trajectory in terms of cost, as specified hereinbelow. This optimal alternative trajectory is presented on the navigation screen 8 by the display unit 6.

The crew is thus informed of the alternative trajectory which is optimal in terms of cost (that is to say the one which exhibits a minimal overall cost) relative to the overall costs associated with the other possible alternative trajectories.

In a particular embodiment, the storage unit 18 and the unit 19 form part of a computation unit 20 which is linked via links 21 and 22, respectively, to the computation units 3 and 4.

The device 1 also comprises a data transmission link 23, which is linked to the computation unit 4 and which makes it possible to transmit data, notably from an airline, such as:

a. objectives in terms of time or fuel;

b. various time-dependent parameters; and

c. information concerning wear of an engine (flight time, change of speed).

This link 23 can be linked to a data source (not represented). In a particular example, it is linked to an input unit 16, which enables a member of the crew to enter the abovementioned information (from the airline) using the input unit 16.

Consequently, and as described in more detail hereinbelow, the device 1 analyzes and restores visually to the crew the range of possibilities available to it in terms of alternative trajectories to the reference flight plan, given constraints that are both operational and environmental to, for example, avoid a weather disturbance, a particular air space or simply profit from an airstream. The device 1 graphically characterizes the impact of each of them so that the crew is thus able to choose directly (by simply reading the navigation screen 8) the best trajectory to perform an avoidance.

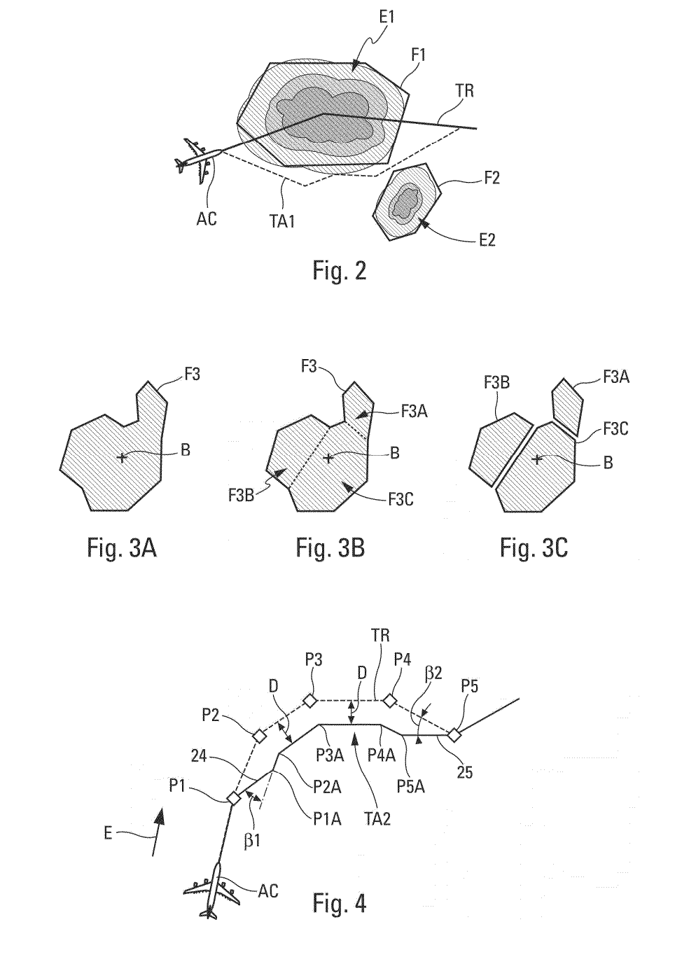

As indicated above, the environment server 9 supplies meteorological data, and envelopes surrounding areas to be avoided, which are necessary to different prediction and cost computations, as specified hereinbelow. The environment server 9 supplies the meteorological data (via the link 10) in the form of a wind grid. This wind grid contains information on the intensities and the directions of the winds (in a wide area around the initially planned flight plan), and envelopes surrounding disturbances, as represented in FIG. 2. In the example of FIG. 2, the aircraft AC flies along a reference trajectory TR (corresponding to the initial flight plan) which passes through a disturbance E1 surrounded by an envelope F1. In this FIG. 2, an alternative trajectory TA1 is also represented which makes it possible to avoid passing through the disturbance E1, as well as another disturbance E2 surrounded by an envelope F2.

Other areas to be avoided are also supplied by the environment server 9 in the form of envelopes with an indication of an additional cost associated with flying over them (tax for example, or infinite cost if the area cannot be flown over).

It will be noted that the weather radars embedded on the aircraft make it possible to generate, usually, a video image of the (wet) meteorological phenomena in a wide area in front of the aircraft. Since this type of information cannot be directly used, it is first processed (detection of the contours of the disturbances, classification according to the danger they represent, correlation with coordinates expressed as latitudes and longitudes, etc.).

The environment server 9 supplies, vectorially, volumes containing the areas to be avoided. At a given altitude, these envelopes are represented by closed polygons F1 and F2, as represented in FIG. 2. They are supplied in the form of lists of points which represent the vertices of the polygons F1 and F2 and which are each defined by a latitude and a longitude.

Preferably, convex polygons are used, as represented by way of example in FIG. 2. If necessary, it is possible to represent a non-convex polygon F3 as represented in FIG. 3A, as the union of a plurality of convex polygons F3A, F3B and F3C, as illustrated in FIG. 3C. FIG. 3B shows the subdivision of the non-convex envelope (or polygon) F3 of FIG. 3A so as to obtain the convex envelopes (or polygons) F3A, F3B and F3C represented in FIG. 3C. Although distinct, it is considered, for the cost computations, that all the polygons F3A, F3B and F3C deriving from a same initial polygon F3 have the same barycenter B. This barycenter B corresponds to that of the initial polygon F3.

Moreover, as indicated above, the computation unit 3 determines alternative trajectories likely to allow a lateral avoidance of a disturbance E1. This computation unit 3 can implement one of the many usual methods that make it possible to determine such alternative trajectories.

The avoidance of meteorological disturbances (if they are of small importance) can be determined using a method that uses a standard so-called “offset” function, which is, for example, incorporated in a flight management system of the aircraft. This method makes it possible to limit crossings with other routes, and it can easily be taken into account by ground control. Furthermore, its impact on the air management of the area in which the aircraft AC is moving is relatively limited.

To do this, the computation unit 3 defines a lateral offset (or lateral deviation). This lateral offset is a translation (to the right or the left) of the current lateral flight plan of the aircraft AC, as represented in FIG. 4. In this FIG. 4, the aircraft AC flies along a flight trajectory TR passing through way points P1, P2, P3, P4 and P5, and an alternative trajectory TA2 is represented. The lateral offset is defined by:

a. an “offset” value D, called “offset distance” in the context of the present invention. The offset distance D of any alternative trajectory TA2 represents a distance of constant value by which this alternative trajectory TA2 is offset laterally in the horizontal plane relative to the reference trajectory TR at least for a central portion of this alternative trajectory TA2;

b. an upstream angle of interception β1 (or distancing angle), in the direction of flight E of the aircraft AC;

c. a departure way point P1 (that is to say the start of avoidance);

d. an arrival way point P5 (that is to say the end of avoidance); and

c. a downstream interception angle β2 (or capture angle).

In an embodiment, in the absence of an interception angle entered by the pilot via the input unit 16, the device 1 uses, for the interception angles β1 and β2, a default value, preferably 30°.

Based on the value D of the offset distance (of the lateral separation or lateral deviation), and from the initial trajectory (and the start and end of avoidance points P1 and P5), received via the link 14, the computation unit 3 determines all of the new alternative trajectory TA2. The latter is defined by a list of way points (defined by their latitude and longitude).

Once the trajectory is constructed, a distancing segment 24 and a capture segment 25 are added. The latter are constructed by respectively considering the distancing angle β1 and the capture angle β2 relative to the segments of the reference trajectory TR (corresponding to the initial flight plan). The alternative trajectory TA2, passing through the way points P1, P1A, P2A, P3A, P4A, P5A and P5, is then obtained.

Hereinafter in the description, the example of alternative trajectories obtained by a lateral offset from the reference trajectory TR, as represented in FIG. 4, is taken into account. However, the device 1 can take into account any type of avoidance trajectories (alternative trajectories), provided that the latter are constructed in a similar manner by varying a small number of parameters.

Thus, in the context of the present invention, the following can notably be taken into account:

a. alternative trajectories, of which the distancing and capture points P1 and P5, and the interception angles β1 and β2, are variable;

b. alternative trajectories made up of two segments: a distancing segment and a capture segment; and

c. alternative trajectories, of which a given number of way points are replaced by way points situated in immediate proximity.

The device 1 thus comprises an automation notably of the alternative trajectory construction operations, which makes it possible to reduce the workload of the crew and obtain results more rapidly with increased accuracy. Furthermore, several alternative trajectories can be obtained and compared by modifying only the offset distance D, the other parameters (headings for the distancing and capture, distancing and capture points) being defined once for all the trajectories.

Moreover, for the computation of the cost, implemented by the central processing unit 4, an objective criterion of choice is determined. This is done through a so-called “cost” function. This function scores each alternative trajectory by taking into account environmental constraints, operational constraints and its consumption in terms of fuel and time.

It is known that a flight management system of an aircraft generally provides an optimization of various parameters of the flight through a single parameter called cost index. This parameter, entered by the crew at the start of the flight, makes it possible to establish a ratio to be followed between the time-dependent costs and those linked to the fuel consumption.

Simply put, the cost C of a flight along at least a portion of a flight trajectory, notably of an alternative trajectory, is defined by the following relationship:

$$C = {C}_{F} \cdot Δ F + {C}_{T} - Δ T + {C}_{0}$$

$$C = {C}_{F} \cdot Δ T \cdot ( \frac{Δ F}{Δ T} + \frac{{C}_{T}}{{C}_{F}} ) + {C}_{0}$$

in which:

C₀ represents so-called fixed costs for the flight;

C_{F} is the cost of a given quantity (weight, volume) of fuel, for example of a kilogram of fuel;

C_{T} is the average cost of a flight time unit, for example of a minute of flight;

ΔF is the quantity of fuel consumed during the flight, expressed for example in pounds; and

ΔT is the total flight time.

The cost index

$$( CI = \frac{{C}_{T}}{{C}_{F}} )$$

is defined as a constant quantity for the flight concerned.

The above equation is then integrated, between two instants of a portion of the flight for which the speed and the engine speed of the aircraft (and therefore the flow of fuel

$$FF = \frac{Δ F}{Δ T}$$

remain almost constant.

The following expression is thus obtained:

C=C_{F}·ΔT·(FF+CI)+C₀.

The values ΔT and ΔF considered correspond to a portion of the flight, for which the flow of fuel is considered as constant.

With the flow of fuel FF being considered as constant, the variations of the total cost of a trajectory depend directly on the flight time. Thus, to compare two given trajectories, the difference between the respective costs of these trajectories is simply taken into account. The following expression is then obtained:

ΔC=C_{F1}·ΔT₁·(FF₁+CI₁)−C_{F2}−ΔT₂·(FF₂+CI₂),

in which the index 1 corresponds to a first trajectory (notably the reference trajectory TR) and the index 2 corresponds to a second trajectory (notably an alternative trajectory).

By considering that the flights following the two trajectories are performed in identical conditions, the following is finally obtained:

ΔC=C_{F}·(ΔT₁−ΔT₂)·(FF+CI).

Consequently, the cost difference ΔC between two trajectories can be obtained by analyzing the flight time difference.

Thus, as a first approximation, over a section of trajectory flown for which the fuel flow rate is constant (short distance, close or equal altitude), and in the absence of any particular additional cost (as specified below), it can be considered that the cost deviation corresponds to the flight time deviation.

The cost function specified above essentially takes into account the objectives of an airline through the value of a cost index, which has been defined by the crew (and entered using the input unit 16 for example), that is to say just a “cost of time/cost of fuel” ratio is taken into account.

However, other costs or cost overheads can be envisaged, such as costs due to indemnities for the passengers who have missed a connection or who have to be housed pending a next flight. Furthermore, different taxes linked to emissions of polluting elements (NOx and CO₂) or to flying over particular areas can also be considered. It is therefore possible to identify other costs linked to the flight and due to a delay of the aircraft, forming part of an “additional cost” in the context of the present invention, such as, for example:

a. costs relating to wear of the engines and of the cell of the aircraft;

b. costs due to missed connections (indemnities, hotel nights, etc.);

c. payment for overtime and/or night work;

d. environmental taxes: any NOx, ETS (Emissions Trading Scheme), flying over particular areas.

The term C₀ involved in the initial cost function can be represented in the following equation Eq1 by a function of the continuous time per segment, for greater accuracy:

ΔC=C_{F}·ΔT·(FF+CI)+C₀(ΔT)

Furthermore, the term C_{F} can contain additional contributions linked to the fuel.

The cost function can be adapted to the need of each airline (short or long haul, low cost flight or not, etc.).

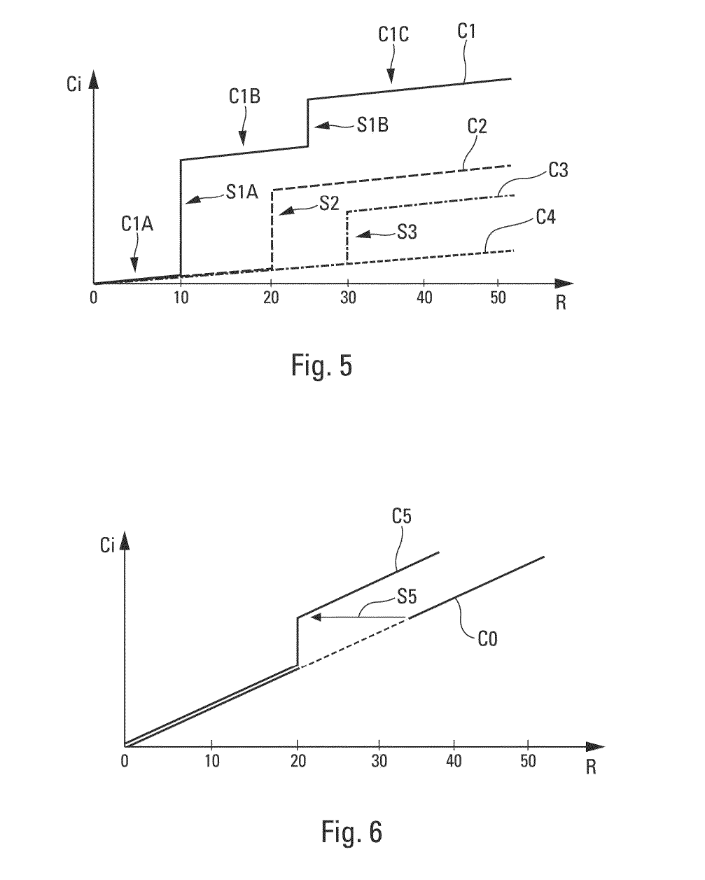

The example represented in FIG. 5 shows different cases of cost overheads Ci generated by delays R (expressed for example in minutes) for a fleet of aircraft having respectively performed different flights V1 to V4. The cost overhead C1, . . . , C4 is a linear function of time (delay R) only by segments, such as, for example, for the segments C1A, C1B and C1C relating to the cost overhead C1. Various value jumps (S1A and S1B for C1, S2 for C2 and S3 for C3) are observed. The latter are due to delays preventing a new rotation, to the payment of overtime for the crew or overnight stays, etc. In the particular example represented, despite the observed jumps, the slope always remains constant.

A cost function, in itself, does not make it possible to optimize all of a fleet of aircraft. However, for an aircraft performing several rotations per day, a delay at the start of the day can affect the rest of the flights in the day. It may be, in particular, that a rotation has to be cancelled because of an excessive delay. These phenomena can be modeled by an affine function by segments which makes it possible for the crew to best optimize the flight.

Thus, the cost C of a flight as a function of the flight time ΔT can be illustrated by:

$$C = \{ \begin{matrix}{a}_{i} \cdot Δ T + {b}_{1} si Δ T ∈ [ {t}_{1} ; {t}_{2} [ \\ {a}_{2} \cdot Δ T + {b}_{2} si Δ T ∈ [ {t}_{2} ; {t}_{3} [ \\ …\end{matrix}$$

Consequently, by going back to the abovementioned equation Eq1, the following is obtained:

$$Δ C = {C}_{F} \cdot Δ T \cdot ( FF + CI ) + {C}_{0} ( Δ T )$$

$${C}_{0} = \{ \begin{matrix}{b}_{1} si Δ T ∈ [ {t}_{1} ; {t}_{2} [ \\ {b}_{2} si Δ T ∈ [ {t}_{2} ; {t}_{3} [ \\ …\end{matrix}$$

Each of the coefficients making it possible to define the additional part of the cost function can be parameterized notably by the airline, for example via the input unit 16.

It is considered that the computation of the cost is implemented by the computation unit 4 in two distinct main phases:

a. a computation of the time needed to fly the determined alternative trajectory; and

b. an addition of penalties (called additional cost), preferably defined by segments as a function of time, to obtain the overall cost associated with the alternative trajectory.

In a particular embodiment, instead of adding a time-dependent term C₀(ΔT), it can be considered that any additional cost is represented by a time penalty, as represented in FIG. 6 in which a time penalty p(ΔT) is illustrated by an arrow S5 to switch from a cost C0 to a cost C5. Thus, instead of ΔT, a time ΔT+p(ΔT) is taken into account, in which p(ΔT) is a constant function by segments. The following is then obtained:

ΔC=C_{F}·(ΔT+p(ΔT))·(FF+CI)

The computation unit 4 performs the computation of the cost from the wind information supplied by the environment server 9. In particular, the computation unit 4 checks whether the alternative trajectory passes through a disturbance to add (or not) a penalty in terms of cost. This penalty makes it possible, in searching for an optimal alternative trajectory, to not obtain a trajectory passing through the disturbance even if the wind is more favorable there.

As indicated above, the cost of an alternative trajectory is determined from the time needed to fly along the alternative trajectory. The computation unit 4 comprises an integrated computation element (not represented), to estimate, rapidly and sufficiently reliably, the flight time necessary for a determined trajectory, by notably taking into account environmental constraints, and in particular the wind. The different winds supplied by the environment server 9 are taken into account through a discrete modeling.

A section of trajectory (representing at least a portion of an alternative trajectory) is considered for which the cost is to be estimated. This section of trajectory is divided into subsegments of identical sizes (length D). It is considered that the wind is constant in intensity and orientation over all of each subsegment. The division (or subdivision) into subsegments therefore depends on the accuracy of the wind grid. It will be noted that it is not useful to have an excessive subdivision (no added accuracy) and that it is prejudicial to have an excessively small subdivision (loss of time). It is preferably considered that the subsegments are at most two times smaller than the minimum spacing between two wind data in the wind grid.

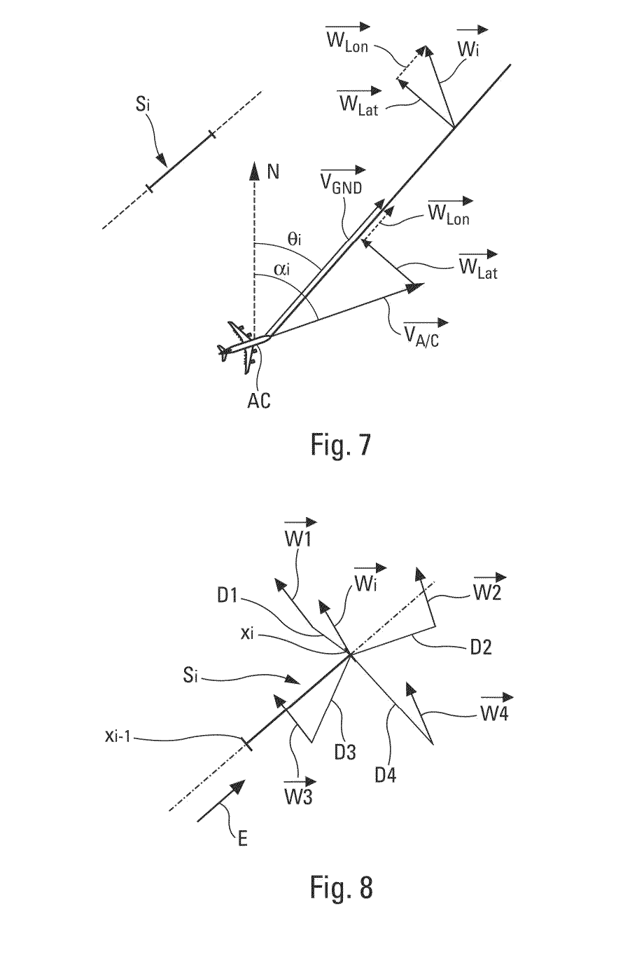

The analysis of the movement of an aircraft AC along a subsegment Si makes it possible to establish the diagram shown in FIG. 7. In this FIG. 7, the following are represented:

a. the wind speed Wi;

b. the speed V_{A/c} of the aircraft AC relative to the air;

c. the speed V_{GND} of the aircraft AC relative to the ground;

d. an angle αi between the speed V_{A/C} and a direction N indicating North; and

e. an angle θi between the speed V_{GND} and the direction N.

By taking into account a predetermined distance Di (length of the subsegments), there is obtained, for each of the subsegments Si (of which the downstream end in the direction of the flight E is named xi), a time (of flight) ΔTi such that:

$$Δ Ti = \frac{Di}{{V}_{GND} ( xi )}$$

Consequently, for all of the section of trajectory considered (for example all of an alternative trajectory), the following flight time is obtained:

$$Δ T = {\sum }_{i}^{ } \frac{Di}{{V}_{GND} ( xi )}$$

If the geometrical characteristics presented in FIG. 7 are taken into account, the following equation Eq2 is obtained:

$$Δ T = {\sum }_{i}^{ } \frac{Di}{{W}_{Lon} ( xi ) + \sqrt{{V}_{A / Ci}^{2} - {{W}_{Lat} ( xi )}^{2}}}$$

The speed V_{A/Ci} of the aircraft AC is always considered constant over a subsegment Si, and the subsegments Si have a distance Di.

By taking into account W_{Lon}(xi) and W_{Lat}(xi) which are, respectively, the longitudinal and lateral components (relative to \vec{V}_{GND}) of the speed of the wind acting at the downstream end xi of the subsegment Si and which verify the following expressions:

W_{Lon}(xi)=Wi·cos(αi−θi)

W_{Lat}(xi)=Wi·sin(αi−θi)

it is deduced from the preceding equation Eq2 that:

$$Δ T = {\sum }_{i}^{ } \frac{Di}{Wi \cdot cos ( α i - θ i ) + \sqrt{{V}_{A / Ci}^{2} - {Wi}^{2} \cdot {sin ( α i - θ i )}^{2}}}$$

In order to obtain the speed and the direction of the wind at a point xi (corresponding to the downstream end of the subsegment Si considered in the direction of flight E of the aircraft AC), an interpolation is performed via the weighted mean of the closest winds. In effect, only a wind grid is available, and the nodes of the grid are not necessarily situated at the ends of the segments.

The interpolation is performed by considering the k closest nodes, as represented in FIG. 8. In this FIG. 8, four wind vectors \vec{W}1 to \vec{W}4 are represented, defined at respective distances D1 to D4 from the point xi. The upstream end of the subsegment Si is named
xi-1.

The contribution of each node is weighted by the distance D1 to D4 from the node to the end xi of the subsegment Si considered. The mean wind \vec{W}i(xi) taken into account for this subsegment Si is computed from the following relationship:

$$\vec{W} i ( xi ) = \frac{{\sum }_{k}^{ } \frac{\vec{W} k}{Dk}}{{\sum }_{k}^{ } \frac{1}{Dk}}$$

As indicated above, a disturbance (or area to be avoided) is supplied by the environment server 9 in the form of one or more polygonal envelopes F1, F2 (as represented for example in FIG. 2). In the context of the present invention, it is considered that:

a. if the alternative trajectory considered does not cross a disturbance, the cost associated with this alternative trajectory is not modified;

b. if the alternative trajectory crosses a disturbance, such as the disturbance E1 (polygonal envelope F1) of FIG. 2, a fixed cost is defined; and

c. if the alternative trajectory crosses an area for which a surcharge is applied, this surcharge (or cost overhead) is added to the cost of the trajectory.

In an embodiment, the computation unit 4 makes the value of the cost of an alternative trajectory passing through a disturbance depend on its distance relative to the center of the disturbance. The trajectory passing through the center of the disturbance has a maximum cost, and the other trajectories have a cost that depends linearly on their offset distance relative to this trajectory passing through the center of the disturbance.

Moreover, by using the cost function and the computation of offset trajectories, it is possible to plot the trend of the cost as a function of the offset distance. It is then possible to identify the most advantageous trajectories.

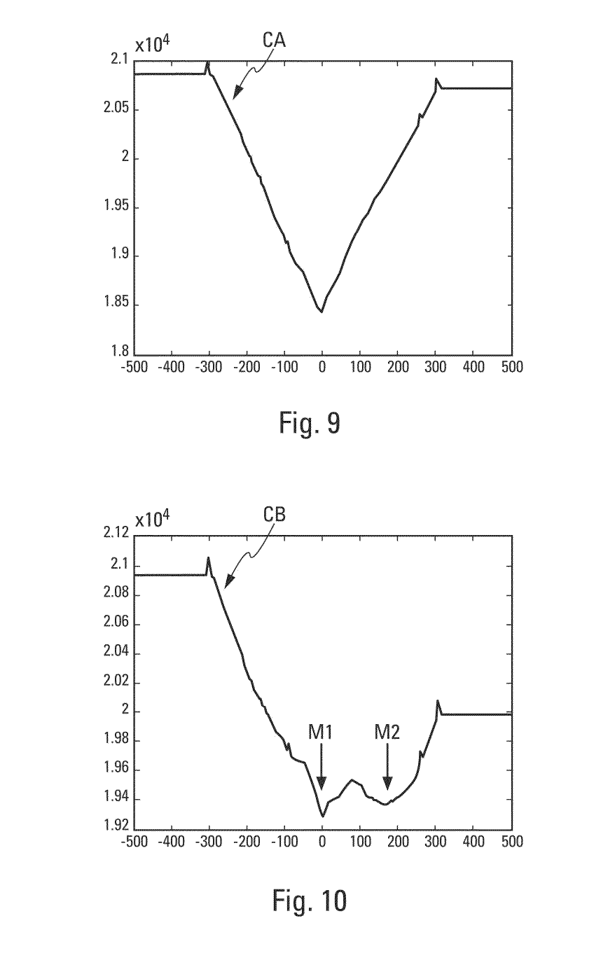

In the case where there is no weather disturbance, it is possible to obtain the curve CA represented in FIG. 9 which defines the cost (expressed for example in seconds) as a function of the offset distance (expressed for example in nautical miles (NM)) to the right (positive values) and to the left (negative values). The minimum is obtained for 0 NM, that is to say for the reference trajectory. In effect, the greater the offset distance, the greater the flight distance to be travelled. In the absence of disturbance (and of significant wind), only the distance has an impact on the assessment of the cost of the trajectory. However, beyond a certain offset distance, the cost of the trajectory becomes constant. Indeed, after a certain offset distance and given distancing and capture angle values, no further trajectory can be constructed. The latter are reduced to the distancing and capture segments.

Moreover, in the presence of a disturbance, the latter will locally modify the appearance of the cost curve as a function of the offset, as represented in the example of FIG. 10. In this example, the winds encountered penalize the consumption on the left of the initial flight plan (negative distance values). Conversely, on the right of the flight plan (positive distance values) there is the center of the disturbance (more favorable winds). Once the offset distance to the right is sufficiently great, it is possible to benefit from more favorable winds, which has the consequence of reducing the cost of the flight. However, the gain which can be obtained is, as the offset distance increases, partly neutralized by the greater distance to be flown. The presence of the disturbance has the consequence of obtaining two minima M1 and M2 on the curve CB of the cost (including an overall minimum M1) in the example of FIG. 10.

Moreover, the unit 19 of the computation unit 20 contains an optimal trajectory search algorithm. Based on the cost assessed (by the computation unit 4) for the trajectory, the unit 19 defines new parameter values transmitted via the link 22 to the computation unit 3, which make it possible for the latter to construct new trajectories to be tested. These processing operations are performed in a loop. The parameters are chosen so as to obtain a convergence toward an alternative trajectory with minimal cost, called optimal trajectory.

In the context of the present invention, this operation can, for example, be implemented by a standard so-called “Nelder-Mead” method, but also by any other multidimensional non-linear optimization method. The dimension of the optimization (that is to say the number of parameters to be determined) depends directly on the computation mode used by the computation unit 3, to construct the alternative trajectories (to be tested).

Moreover, a human/machine interface 15 manages the inputs and outputs and the interactions with the crew and it takes into account the various parameter inputs (points of avoidance and of capture). It also produces the display notably of the trajectory considered as optimal, and the range of alternative trajectory solutions.

In a particular embodiment, the display unit 6 forms part of the human/machine interface 15 which further comprises the input unit 16. This input unit 16 enables an operator, notably a pilot of the aircraft, to enter data into the central processing unit 2, via a link 17. This input unit 16 can correspond to any standard unit type (touchscreen, numeric keypad, keyboard and/or computer mouse, etc.) making it possible to input data.

Given the assessment of different trajectories, a mapping is supplied to the crew via the navigation screen 8 to enable it to identify the most favorable avoidance areas. Each trajectory can be assigned a color dependent on its cost, as represented in FIG. 11.

In the case where several different sections of trajectories are superposed, the priority (visibility) is given to the trajectory of lowest cost. Thus, there is an assurance that the optimal trajectory is always displayed.

In the examples represented in FIGS. 11 and 12, a flight plan of an aircraft AC going from a way point PD to a way point PF is considered. The cruising altitude is, for example, limited to the last level for which the environment server 9 has a wind grid, for example at the flight level FL 300.

A disturbance appears on this trajectory TR. By way of example, a single disturbance delimited by a polygonal envelope F0 is considered.

From the reference trajectory TR, the central processing unit 2 constructs a set of alternative trajectories TA3 and TA4 and computes the corresponding overall costs, and an optimal trajectory TO. These trajectories are represented on the navigation screen 8 by different colors corresponding to different costs, as illustrated by the different plots of said trajectories TA3, TA4 and TO in FIG. 11. A particular color is therefore applied to each of these trajectories dependent on the corresponding overall cost (for example red for a high cost, yellow for a median or average cost, green for a low cost).

Moreover, in an embodiment illustrated in FIG. 12, the costs are represented on the navigation screen 8 in the form of areas Z1 to Z3 of different colors, namely, for example:

a. the dark grey area Z1 in FIG. 12, which is, for example, presented in red on the display produced on the navigation screen 8 and which corresponds to an area with high cost;

b. the light grey area Z2 in FIG. 12, which is for example presented in yellow on the display produced on the navigation screen 8 and which corresponds to an area with average cost; and

c. the cross-hatched area Z3 in FIG. 12, which is for example presented in green on the display produced on the navigation screen 8 and which corresponds to an area with low cost. This area Z3 includes the disturbance (envelope F0). The trajectories which pass through the disturbance are identified by their high cost.

The alternative trajectories TA3 and TA4 and the areas Z1 to Z3, represented notably by different colors, form part of the abovementioned indication elements which are displayed by the display unit 6 on the navigation screen 8 and which illustrate the cost impacts generated by lateral route deviations.

In this embodiment, the optimal trajectory TO is also represented. Preferably, this optimal trajectory TO is highlighted by a graphic and/or a particular color to be easily and rapidly identified and located by a crew member. In the example represented, the optimal trajectory TO is tangential to the envelope F0 of the disturbance along the right side 26 (FIG. 12).

Moreover, the device 1 also comprises a selection and activation unit, for example forming part of the input unit 16. This selection and activation unit enables a pilot to select an alternative trajectory presented on the navigation screen 8 and activate it. The aircraft is then guided in the usual manner (by guidance means that are not represented) to follow the alternative trajectory thus selected and activated by the pilot.

Thus, the crew has, by virtue of the device 1 as described above, information that it needs to decide on the best possible avoidance strategy (in the presence of a meteorological phenomenon for example) by assessing, directly on the navigation screen 8, the impacts associated with the different possibilities available to it to deviate from the reference trajectory TR.

The device 1 provides a graphic representation, on each side of the flight plan, of the cost or cost overhead generated by a lateral avoidance, and more generally by a modification of the lateral route. Furthermore, the cost overhead information supplied to the crew relates to all the lateral avoidance possibilities around the aircraft AC so that the crew can identify the best avoidance solution immediately and rapidly, graphically and at a glance, without having to model the route deviation in a temporary or secondary flight plan.

Moreover, in a particular embodiment (not represented), the costs are represented on the navigation screen in the form of areas of different colors. Each of these areas presents a given cost different from the cost of another area. This particular embodiment makes it possible to indicate to the crew the cost overhead generated as a function of the passage into one or other of the different areas.

1. A method for determining information regarding costs in flying an aircraft along an alternative flight trajectory, the method comprising:
a) automatically determining alternative flight trajectories, and determining for each of the alternative flight trajectories a horizontal offset between the alternative flight trajectory and the reference flight trajectory;
b) automatically computing for each of the alternative flight trajectories, an associated cost associated with the alternative flight trajectory indicating a cost of flying the aircraft along the alternative flight trajectory; and
c) presenting on at least one navigation screen of the aircraft, one or more graphical or alphanumeric indication elements that convey the position and the overall cost for one or more of the alternative flight trajectories.

2. The method as claimed in claim 1, further comprising:
selecting from the alternative trajectories an optimal alternative flight trajectory which is optimal in terms of cost; and
the step of presenting includes presenting the indication elements associated with the optimal alternative flight trajectory on the navigation screen.

3. The method of claim 1, further comprising an operator to select one of the alternative trajectories presented on the navigation screen, and
activating the aircraft to follow the selected alternative flight trajectory.

4. The method of claim 1, further comprising, for each of two or more the alternative flight trajectories having different horizontal offsets from the reference flight trajectory have distances, determining an offset distance of the alternative flight trajectory wherein the offset distance represents a distance by which the alternative flight trajectory is horizontally offset relative to the reference flight trajectory at least for a central portion of the alternative flight trajectory.

5. The method as in claim 1, wherein the step a) comprises determining the alternative trajectories which avoid passing the aircraft through a defined avoidance areas in of the environment outside of the aircraft.

6. The method as in claim 1, wherein the step b) comprises, for each alternative flight trajectory:
b1) computing a flight time along the alternative flight trajectory;
b2) computing a cost of flying the aircraft for the computed flight time; and
b3) including the computed cost of flying the aircraft for the computed flight time in the overall cost for the alternative flight trajectory.

7. The method as in claim 6, wherein the step b1) comprises computing the flight time by dividing the alternative flight trajectory into a plurality of subsegments and by computing and aggregating the flight times ΔTi of the subsegments, the flight time ΔTi of each of the subsegments (Si) being computed using the following expression:
$$Δ T i = \frac{D i}{{W}_{Lon} ( xi ) + \sqrt{{V}_{A / C} {i}^{2} - {{W}_{Lat} ( xi )}^{2}}}$$
in which:
W_{Lon}(xi) and W_{Lat}(xi) are, respectively, longitudinal and lateral components of a wind speed corresponding to the sub-segment (Si);
V_{A/C}i is a speed of the aircraft relative to the air; and
Di is the distance of the subsegment.

8. The method of claim 6 wherein step b3) comprises computing the overall cost ΔC, using one of the following expressions:
ΔC=C_{F}·ΔT·(FF+CI)+C₀(ΔT)
ΔC=C_{F}·(ΔT+p(ΔT))·(FF+CI)
in which:
C_{F} is a cost expressed in a currency unit for a given quantity of fuel;
ΔT is said flight time;
FF is a parameter illustrating a fuel flow, this parameter being considered as constant;
CI is a cost index representing a ratio between a cost dependent on a flight time of the aircraft (AC) and a cost dependent on a fuel consumption of the aircraft (AC);
C₀(ΔT) is a function dependent on time and comprising the additional cost; and
p(ΔT) is a time value incorporating the additional cost.

9. The method as in claim 1 wherein the steps a) and b) implement a multidimensional non-linear optimization method.

10. The method as in claim 1 further comprising saving in a non-transitory memory the alternative trajectories determined in the step a), and the associated overall costs computed in the step b).

11. A device for determining and presenting, on an aircraft, cost impacts generated by lateral route deviations of the aircraft relative to a references flight trajectory, the device comprising:
an information processing unit including a processor and a non-transitory memory storing instructions which cause the information processing unit to:
determine different alternative flight trajectories, wherein each of the alternative trajectories are offset laterally in a horizontal direction from the reference trajectory; and
computing, for each of the alternative trajectories, an associated overall cost of the alternative trajectory and generating a graphical or alphanumeric indication element of the cost of flying the aircraft along the alternative trajectory; and
a display unit on the aircraft including at least one navigation screen, wherein the indication element for at least one of the alternative trajectories is displayed on the navigation screen.

12. The device in claim 11, wherein the instructions further causes the information processing unit to select from the alternative trajectories an optimal alternative trajectory in terms of cost, wherein the selection includes consideration of the overall cost, and the indication element for the optimal alternative trajectory is displayed on the navigation screen.

13. The device in claim 11 further comprising an environment server configured to supply to the information processing unit meteorological data, and information defining avoidance areas indicating regions of the outside environment to be avoided by the aircraft.

14. The device as in claim 11, further comprising a performance server configured to supply to the information processing unit information indicating flight performance of the aircraft.

15. An aircraft comprising the device recited in claim 11.

16. A method for determining information regarding costs in flying an aircraft along an alternative flight trajectory, the method comprising:
receiving information defining an airspace region to be avoided by the aircraft;
automatically determining whether a reference flight trajectory of the aircraft passes through the airspace region to be avoided;
in response to the determination that the reference flight trajectory passes through the region to be avoided, determining horizontal offset from the reference flight trajectory and for each horizontal offset determining an alternative flight trajectory using the horizontal offset;
automatically computing for each of the alternative flight trajectories, a cost associated with the alternative flight trajectory indicating a cost of flying the aircraft along the alternative flight trajectory, wherein the computation of the associated costs uses the determined horizontal offset; and
automatically presenting on a navigation screen of the aircraft, one or more graphical or alphanumeric indication elements that provide information regarding a flight path horizontal and the cost for one or more of the alternative flight trajectories.

17. The method as in claim 16, further comprising determining which of the alternative trajectories does not pass through the region to be avoided and the step of automatically computing is performed on the determined alternative flight trajectory that do not pass through the region to be avoided.

18. The method as in claim 16, the automatic computing of the cost for each of the alternative flight trajectories includes:
computing a flight time along the alternative flight trajectory;
computing a cost of flying the aircraft for the computed flight time; and
including the computed cost of flying the aircraft for the computed flight time in the overall cost for the alternative flight trajectory.

19. The method as in claim 18, wherein computing the flight time includes dividing the alternative flight trajectory into a plurality of subsegments and by computing and aggregating the flight times ΔTi of the subsegments, the flight time ΔTi of each of the subsegments (Si) being computed using the following expression:
$$Δ T i = \frac{D i}{{W}_{Lon} ( xi ) + \sqrt{{V}_{A / C} {i}^{2} - {{W}_{Lat} ( xi )}^{2}}}$$
in which:
W_{Lon}(xi) and W_{Lat}(xi) are, respectively, longitudinal and lateral components of a wind speed corresponding to the sub-segment (Si);
V_{A/C}i is a speed of the aircraft relative to the air; and
Di is the distance of the subsegment.
